(19) United States
(12) Patent Application Publication
(10) Pub. No.: US 2013/0269247 A1
(43) Pub. Date: Oct. 17, 2013

(54) Tube Shaped Device Filled With A Liquid Means For The Plants Nutrition And/Or Protection, A Process Of This Device Construction And Its Usage

(71) Applicant: Marko Kostic, Beograd (RS)

(72) Inventor: Marko Kostic, Beograd (RS)

(21) Appl. No.: 13/977,154

(22) PCT Filed: Dec. 29, 2011
(86) PCT No.: PCT/RS11/00017

§ 371 Date: Jun. 28, 2013

(30) Foreign Application Priority Data
Dec. 30, 2010 (RS) P-2010/0576

(51) Int. Cl. A01G 29/00

(52) U.S. Cl. CPC A01G 29/00
USPC 47/48.5; 264/232

(57) ABSTRACT

This invention is related to device, its production process and also to the usage of the trbe shaped device (1) filled with a liquid means (6) for the plats nutrition/protection, which is inserted into the substrate (8) as much as closer to the main plant, where discharge occurs. Novelty is reflected in the way of forming and removing the shutters now obtained by heating wax, resin, plastic, rubber, hot-melt glues and compounds of similar characteristics, upon whit they become a liquid mass in which the openings of the tube are to be immersed; in this way, the film, after being hardened, forms the membrane (3a, 3b) which, due to the pressure to the sides of the tube (1), out-breaks; unlike of classic shutters which makes production and usage more complicated and makes some waste after being used. If the means which will form an clastic membrance are in charge, its removing is to be done rather by divestment tan by breaking or penetration (by direct pressure)

### TECHNICAL FIELD

This invention more broadly belongs to the area of agriculture i.e. to the area of the plants nutrition and protection in more narrow sense, and it is related to the production and usage of the tube shaped device, filled with a liquid means for the plants nutrition and/or protection, inserted into a substrate where discharge occurs. It also belongs to the class of devices for nutrition of roots i.e. fertilizer injecting into the root system, but it also provides other function i.e. an application of assets for plant protection.

According to an the International Patent Classification, a designation is: A01C 23/02 (2006.01) and A01G 29/00 (2006.01).

### TECHNICAL PROBLEM

A technical problem which is to be solved with this invention is how to structurally resolve a device for the plants nutrition and/or protection, which is easy to be used, and which provides an accurate dosage of assets for the plants nutrition and/or protection and which prevents a direct contact between the user and preparation, considered as the most important in working with pesticide.

### BACKGROUND ART

The closest state of art is represented by the patent registration P-2009/0494, of the same author, where the closing has been defined by using mechanical shutters, as well as by gluing the tube ends; in that case, it is required to remove them physically. Disadvantages are in relatively complicated usage, quantity of material used, some additional steps in construction complicating and making the production process more expensive, then in problematic hermetic and aesthetical closing the tube with variable openings. By this invention, all stated problems are to be resolved.

### DISCLOSURE OF INVENTION

This invention is related to the tube shaped device, the process of its production and usage, filled with liquid means for the plants nutrition or/and protection, inserted into the substrate, the best is close to the main plant, where discharge occurs; here, a novelty is related to the way of production and usage; it means they are now completely simplified, and costs are reduced to a minimum. The novelty is reflected in the way of the shutter forming and removing, being obtained now by heating wax, resin, rubber, plastic, by hot-melt glue and compounds of similar characteristics; after that, they turn into a liquid mass in which the openings of the tube are immersed with which the film is put on; after being hardened that film forms a membrane which bursts on the place of its appearance, because of the pressure to the sides, unlike conventional shutters which make production and usage more complicated and leave waste after being used. If the assets which shall form an elastic membrane are in charge, its removing is to be performed by divestment or penetration (direct pressure) rather than by breaking. Closing is also to be achieved by using glues and lacquers in liquid, as well as compounds with similar characteristics which get hardened in the air. In order to perform the breaking of membrane by a pressure to the sides, it is recommended to use thin-walled tubes; the best are made of plastic mass, simultaneously being very cheap.

### BRIEF DESCRIPTION OF DRAWINGS

This invention is described in detail in an example of the usage:

FIG. 1—it shows a longitudinal section of the device filled by liquid means for plant and membrane nutrition/protection

FIG. 2—shows a detail A from the FIG. 1

FIG. 3—shows a cross section

FIG. 4—shows a longitudinal section of device with porous material, inserted on both sides and little balls thrown in the pipe.

FIG. 5—shows a detail B of the FIG. 4

FIG. 6—shows longitudinal section of device with porous material when directly influences leakage of liquid means for plant nutrition/protection.

FIG. 7—shows injection of the tube into a dissolved means for forming the membrane

FIG. 8—shows a device in an orthogonal projection

FIG. 9—shows an usage of the device

### BEST MODE FOR CARRYING OUT THE INVENTION

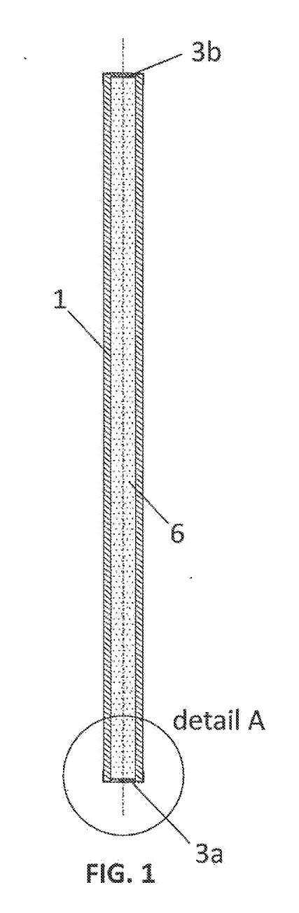

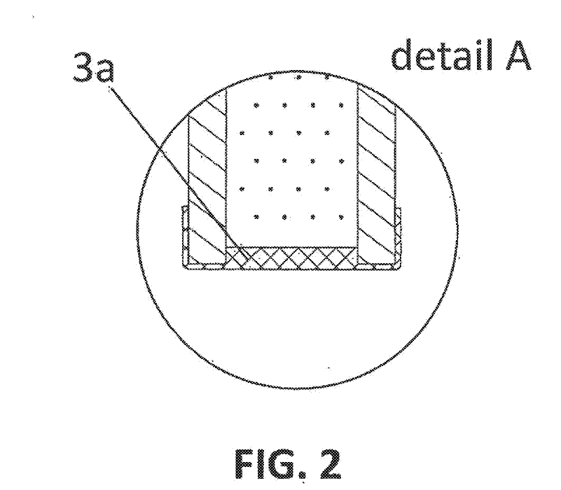

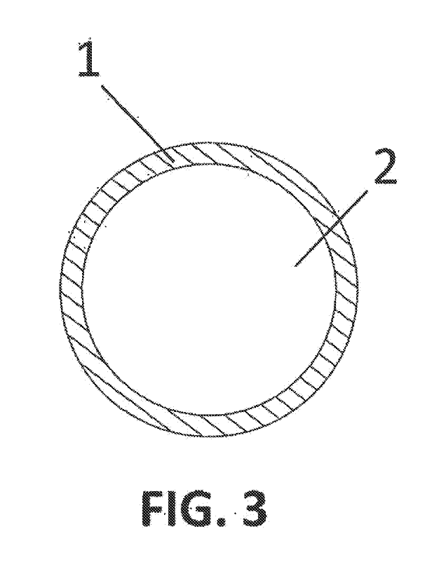

These figures show the device filled with a liquid means 6 for the plants nutrition/protection, the device production process, as well as the usage of the last. FIG. 1 shows the device consisted of the tube 1, being limited by the lower membrane 3a and the upper membrane 3b at its edges. A consequence of this construction is forming the reservoir 2.

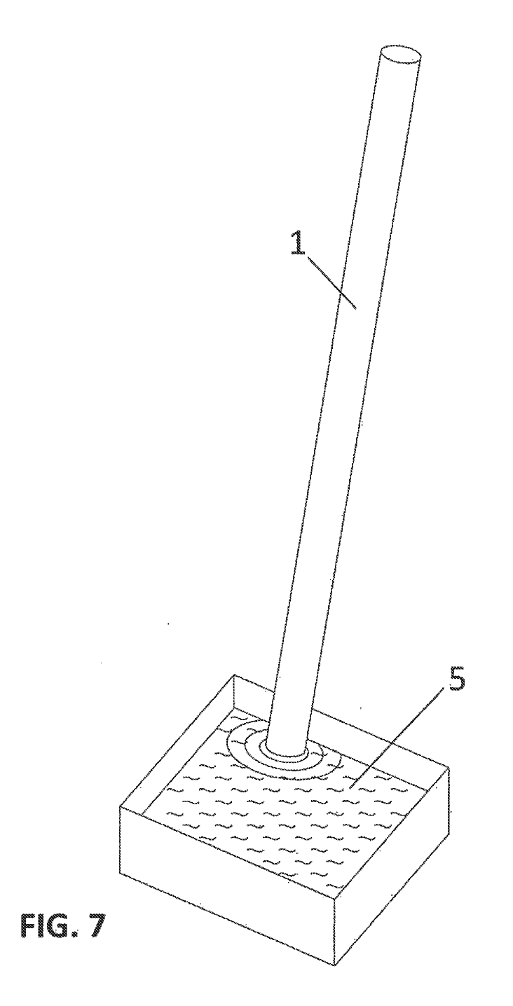

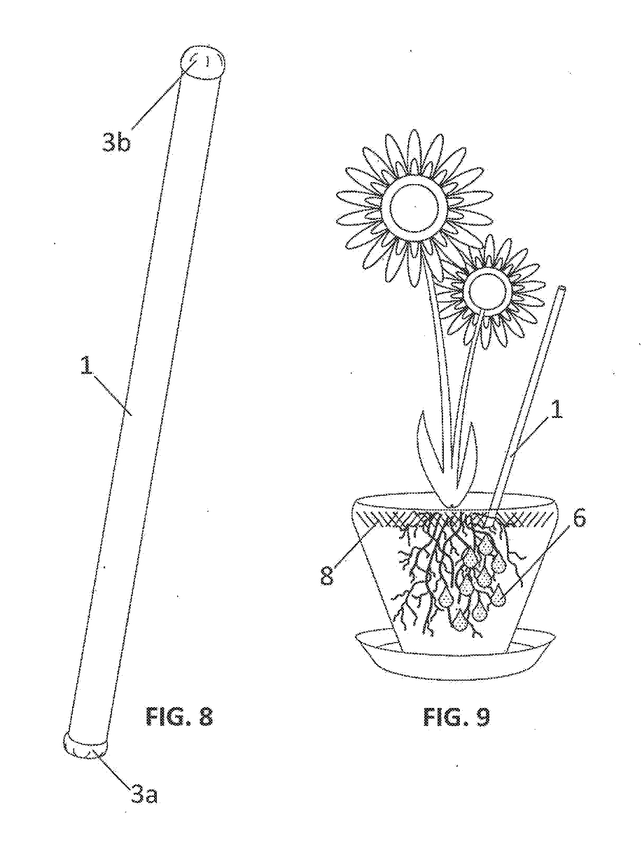

The device production process is shown in the FIG. 7; one end of the tube 1 is immersed into the means 5 for forming the membranes 3a, 3b, where, while being extracted, a film appears and gets hardened and in that way forms a solid and impermeable membrane 3a. After that, from an open part of the tube 1, a liquid means 6 for the plants nutrition/protection is poured into the reservoir 2; now, the tube 1 is to be closed completely by the same process i.e. an open end of the tube is immersed into the means 5, where, after the film is hardened, the membrane 3b is created. Hardening the film i.e. forming the membranes is done in the air or by an immersion into the liquid of lower temperature, depending on characteristics of the means 5.

A creation of the membranes 3a and 3b is achieved by the immersion of the tube 1 opening into dissolved funds 5, such as wax, resin, rubber, hot-melt glues and compounds with similar characteristics which, after cooling become solid, as well as by using liquid glues and lacquers and compounds of similar characteristics that become hardened in the air. The film can be thinner or thicker, depending on the needs (it is under different pressure, depending on thickness and used means). The membranes 3a and 3b may be formed by the combination of means too, in order of improvement of their characteristics by applying more films.

Closing the tube 1 is provided by a new production procedure and with variable radiuses of openings which are often to be found in cheep packaging production, such as plastic drinking straws or other thin-walled tubes where an application of the shutter doesn't have to provide hermetic closing necessarily neither be aesthetically well fitted, depending on the shutter's construction. An advantage of stated means 5 for getting the membranes 3a and 3b is a quality bonding to other materials because of their characteristics: in this case, there is material of the tube 1 in charge, which guarantees a tightness and hermetic closing.

In using the device, first action which must be done is removing a lower membrane 3a, by pressure to the sides of the tube 1, on the place of the membrane creation and/or by direct pressure on the membrane 3a, which leads to its bursting i.e. closing the crack; then, the device is inserted into the substratum 8, if possible as much as closer to the main plant. In the same manner, removing of the upper membrane 3b is to be done, which provides aeration and drainage of the liquid means 6 for the plants nutrition/protection. In this case, order of use may be reversed i.e. it is possible first to remove the membrane 3b and after the setting of the tube 1 into the substrate 8, removing of the membrane 3a.

If the means 5 for getting membranes is elastic after being hardened, removing is to be done by divestment and penetration, rather than by breaking.

In the case of necessity of slowing down drainage of the means 6 for the plants nutrition/protection, porous material 4 is to be inserted into the reservoir 2; porous material 4 directly slows down leaking of the liquid means 6 or it slows down aeration into the reservoir 2, depending on position in the tube 1; in that way, it directly slows down leaking of the means 6 for the plants nutrition/protection; it provides a gradual nutrition of the plants.

While closing the opening of the tube 1 by the means 5 for membranes creation, porous material 4 is drawn into the reservoir 2 in order to prevent their contact and its clogging.

It is possible to install more porous material 4 in the device which leads to an additional slowing down of leaking of the means 6 for the plants nutrition/protection, as well as a harder clogging of pores, as a consequence of insertion into substrate 8.

Because of an additional slowing down of leaking of the liquid means 6 for the plants nutrition/protection, porous material 4 is installed on both ends, which also differs it from device stated in the state of techniques. An advantage of porous material installed on both ends is in the fact that it provides usage of permeable porous materials 4 which will be more difficult to be clogged while inserting into the substrate 8. In the case that porous material 4 is settled on both ends, order of use is not important, unless otherwise defined because of their characteristics.

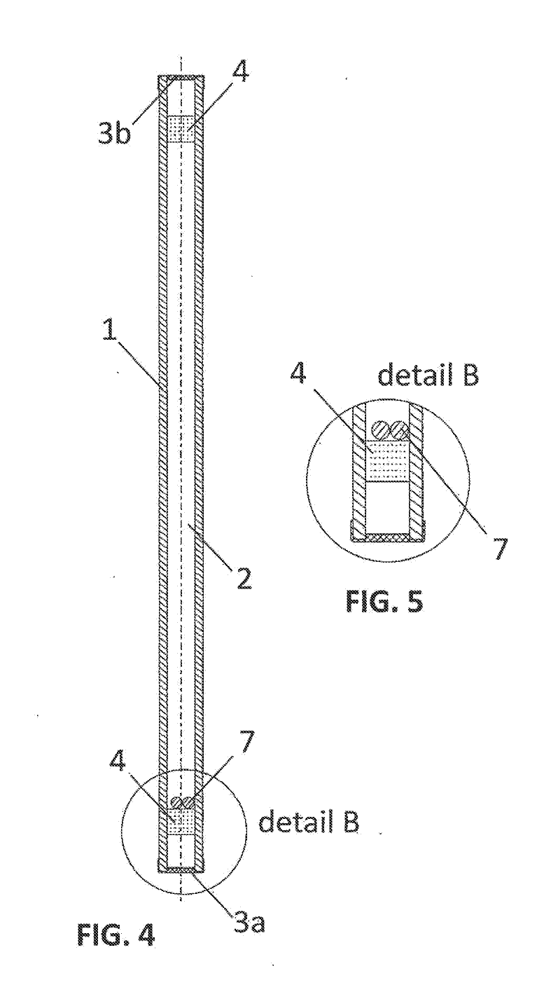

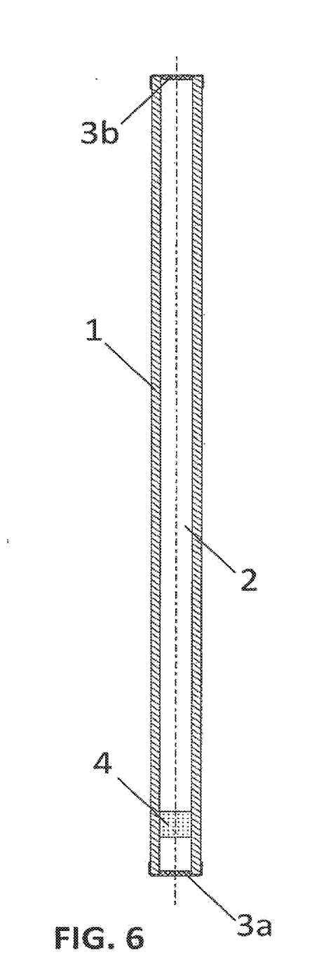

If characteristics of the liquid means 6 for the plants protection/nutrition, such as subsidence, clotting, crystallization and others, require so, in the reservoir 2, except of porous material 4, the bodies 7 are to be inserted too, the best are small balls, for mixing and breaking of liquid means 6 for the plants nutrition/protection, FIG. 4.

This invention resolves also a problem of handling with liquid means 6 for the plants nutrition/protection; it storages them into the tube 1 being hermetic closed, and while using, it is utilized together with liquid means 6 for the plant nutrition/protection. In this purpose, the means which are possible to be taken by the plant by its root, are used.

Thickness of the membranes 3a and 3b may be controlled, which is the way of influencing the quality of closing; it is extremely important for any kind of manipulation where is possible to find a mechanical action and increasing the pressure inside of the tube and on the membranes 3a and 3b. Consequence of the last, are out-breaking and breaking the membranes 3a, 3b and leakage of liquid means 6 for the plants nutrition/protection. Characteristics of the membranes 3a, 3b depend on the number of films deposited; temperature of heating the means for the membranes creation, speed of getting hardened, tube ends immersion depth, usage of the means for forming the membrane as well as of position of the tube while hardening.

Time needed for hardening is possible to make shorter by inserting in the middle with more suitable temperature than the one in working room, and in that purpose, ventilation is possible to be increased. Depending on position of the tube 1 while hardening used means 5 for creation of the membrane, its shape is also to be created; if immersed side after extraction is left down, it may be convex; if it is turned up, it may be drawn into the tube. All characteristics of membranes 3a and 3b may vary also in the process of combining materials and number of immersion.

A minimal consumption of materials, because of the shutter elimination, decreases production price and an amount of waste, and construction provides extremely easy application and, simultaneously prevents the contact between the user and liquid means 6 for the plants nutrition/protection.

A drastic reduction of production costs is outlined in elimination the usage of the shutter which seals hermetically, especially if it is required to use some additional means for sealing; the reduction is also possible to be seen in reduction of time needed for complete device production.

1. The tube shaped device filled with liquid means for the plants nutrition/protection, characterized by its composition of tube (1) on both sides closed by the membranes (3a and 3b) and by the reservoir (2) formed by the tube (1) and the membranes (3a and 3b), filled with liquid means (6) for the plants nutrition/protection.

2. The tube shaped device filled with liquid means for the plants nutrition/protection, according to the request 1, characterized by the reservoir (2) with one or more porous material (4) immersed into.

3. The tube shaped device filled with liquid means for the plants nutrition/protection characterized by the reservoir (2) in which there are one or more bodies (7) to be inserted, with the purpose of mixing and breaking the liquid means (6).

4. Production process for the tube shaped device filled with liquid means for the plants nutrition/protection, characterized by the one end of the tube (1) immersed into the means (5) for the membranes creation, where, while extracting, a film appears and gets hardened in the air, forming a solid and impermeable membrane (3a); then, from an open side of the tube (1) a liquid means (6) for the plants nutrition/protection is poured into the reservoir (2) upon which the open end of the tube (1) is to be immersed into the means (5), where, after extraction and hardening of appeared film, the membrane (3b) is created.

5. Production process of the tube shaped device filled with a liquid means for the plant nutrition/protection, according to the request 4, characterized by the means (5) that could be wax, resin, plastic, hot-melt glues and compounds of similar characteristics which, by heating, become liquid, as well as ordinary glues and lacquers already being liquid, and compounds of similar characteristics.

6. Usage of the tube shaped device filled with a liquid means for the plants nutrition/protection, characterized by the pressure to the sides of one end of the tube (1) which causes out-breaking of the lower membrane (3a), after which that end of the tube is inserted into the substrate (8), as much as possible close to the main plant, and after that, by the pressure to the sides of another end of the tube (1), the higher membrane (3b) out-breaks.

7. Usage of the tube shaped device filled with a liquid means for the plants nutrition/protection, according to the request 6, characterized by removing the membranes (3a and 3b) by divestment or penetration.
